(19) United States
(12) Patent Application Publication
(10) Pub. No.: US 2025/0191146 A1
(43) Pub. Date: Jun. 12, 2025

(54) GENERATIVE ADVERSARIAL NETWORKS FOR TRANSFORMER-BASED DEHAZING

(71) Applicant: SAMSUNG ELECTRONICS CO., LTD., Suwon-si (KR)

(72) Inventors: Sobhan Soleymani, San Diego, CA (US); Shuangquan Wang, San Diego, CA (US)

(73) Assignee: SAMSUNG ELECTRONICS CO., LTD., Suwon-si (KR)

(21) Appl. No.: 18/910,923

(22) Filed: Oct. 9, 2024

Related U.S. Application Data
(60) Provisional application No. 63/606,851, filed on Dec. 6, 2023.

(51) Int. Cl. G06T 5/73

(52) U.S. Cl. CPC G06T 5/73; G06T 2207/20081; G06T 2207/20084

(57) ABSTRACT

Methods and systems for performing image dehazing, including: obtaining an input image; estimating a transmission map by providing the input image to a dehazing transformer model, wherein the dehazing transformer model is trained by performing a training process on a cyclic generative adversarial network (GAN) comprising the dehazing transformer model; and generating an output image based on the transmission map, wherein an amount of haze included in the output image is less than an amount of haze included in the input image.

### CROSS-REFERENCE TO RELATED APPLICATION

This application claims the priority benefit under 35 U.S.C. § 119(e) of U.S. Provisional Application No. 63/606,851, filed on Dec. 6, 2023, the disclosure of which is incorporated by reference in its entirety as if fully set forth herein.

### TECHNICAL FIELD

The disclosure generally relates to image dehazing. More particularly, the subject matter disclosed herein relates to a transformer-based dehazing model which is trained as part of a cyclic generative adversarial network based on paired and unpaired image samples.

### SUMMARY

When an image is captured by a camera, for example a camera of an electronic device such as a mobile device, the image may be affected by haze. Haze may refer to the result of scattering of light by particles in the atmosphere. Accordingly, the electronic device may perform dehazing to estimate a haze-free image. This haze-free image may have improved visual quality, which may be beneficial for computer vision tasks such as image segmentation and object detection.

To perform dehazing, some prior-based approaches involve estimating a transmission map by investigating priors. However, in practice, the priors may be easily violated, which may lead to a reduction in dehazing performance.

Other approaches may involve deep neural network (DNN) dehazing models which rely on datasets that include hazy image samples paired with clean image samples. However, because of the scarcity of paired clean-hazy image samples, some DNN dehazing models have focused on using synthetic hazy image samples for training, which may result in a domain gap between images output by the DNN dehazing models and the input images on which they are based.

Other approaches may involve convolutional neural network (CNN) encoder/decoder architectures. However, these architectures may have a limited receptive field, which may cause performance shortcomings because dehazing tasks may require long-range spatial dependency.

To overcome these issues, systems and methods are described herein are directed to cyclic generative models for training dehazing and rehazing models based on both paired and unpaired image samples. In addition, embodiments may use vision transformers as image generators in a dehazing path and a rehazing path of the training process, and may decompose the dehazing path into depth and density computations.

The above approaches improve on previous methods because the cyclic generative model may reduce the number of paired clean and hazy image samples which are needed for training. In addition, the vision transformers used in the above approaches may provide improved long-range spatial dependency between the paired clean and hazy image samples which are used, and may provide improved performance of depth estimation which may result in better performance in the rehazing path. Further, the above approaches may provide spatially consistent reconstruction due to decomposing the dehazing path into depth and density. Still further, by using both paired and unpaired samples, the above approaches may provide improved reconstruction of details while providing strong constraints for dehazing.

In an embodiment, a method of performing image dehazing comprises: obtaining an input image; estimating a transmission map by providing the input image to a dehazing transformer model, wherein the dehazing transformer model is trained by performing a training process on a cyclic generative adversarial network (GAN) comprising the dehazing transformer model; and generating an output image based on the transmission map, wherein an amount of haze included in the output image is less than an amount of haze included in the input image.

In an embodiment, a system for performing image dehazing comprises: a training module configured to perform a training process on a cyclic generative adversarial network (GAN) comprising a dehazing transformer model; and an electronic device configured to: obtain an input image; estimate a transmission map by providing the input image to the dehazing transformer model; and generate an output image based on the transmission map, wherein an amount of haze included in the output image is less than an amount of haze included in the input image.

### BRIEF DESCRIPTION OF DRAWING

In the following section, the aspects of the subject matter disclosed herein will be described with reference to exemplary embodiments illustrated in the figures, in which:

FIG. 1 is a block diagram showing an image dehazing system, according to embodiments.

FIG. 2 is a block diagram showing a training module for training a cyclic generative adversarial network including a dehazing transformer model, according to embodiments.

FIG. 3 is a block diagram showing a dehazing network included in a dehazing-rehazing path, according to embodiments.

FIG. 4 is a block diagram showing a dehazing network included in a rehazing-dehazing path, according to embodiments.

FIG. 5 is a block diagram showing a rehazing network included in a rehazing-dehazing path, according to embodiments.

FIG. 6 is a block diagram showing a dehazing network included in a rehazing-dehazing path, according to embodiments.

FIG. 7 is a flow chart of a process for performing image dehazing, according to embodiments.

FIG. 8 is a flow chart of a process for training a cyclic generative adversarial network including a dehazing transformer model, according to embodiments.

FIG. 9 is a block diagram of an electronic device in a network environment, according to an embodiment.

FIG. 10 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

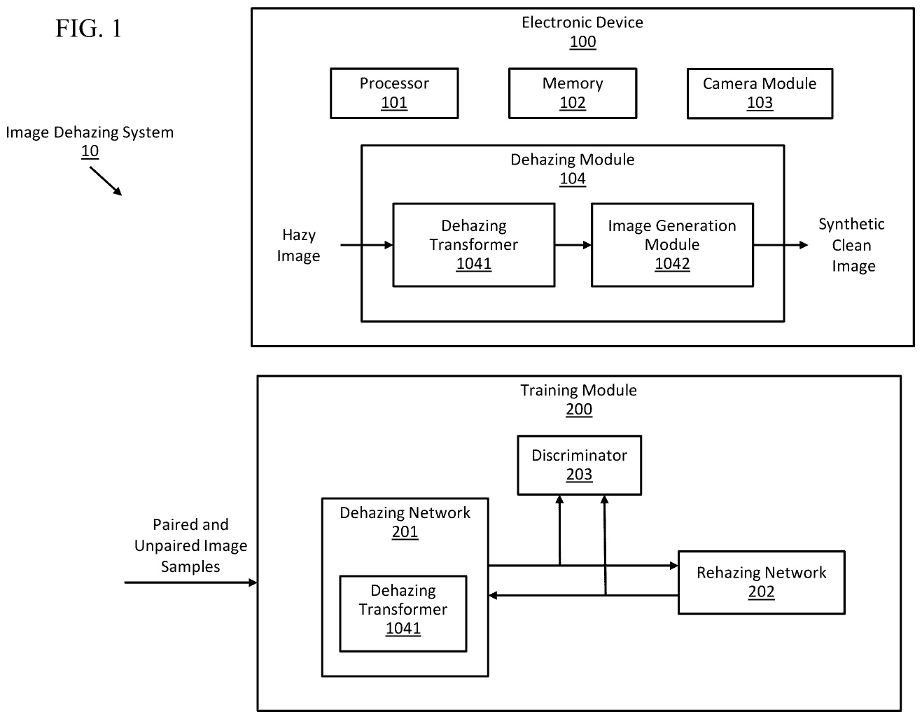

FIG. 1 is a block diagram showing an image dehazing system, according to embodiments. As shown in FIG. 1, the image dehazing system 10 may include an electronic device 100 and a training module 200.

The electronic device 100 may include a processor 101, a memory 102, a camera module 103, and a dehazing module 104, which may include a dehazing transformer model 1041 and an image generation module 1042. The processor 101 may control overall operations of the electronic device 100, for example based on instructions stored in the memory 102. As discussed above, when an image is captured, for example using the camera module 103, an image quality of the captured image may be degraded by the presence of haze, which may be the result of scattering of light by particles in the atmosphere. The presence of haze may produce an image which is visually unappealing, and which may also be detrimental to computer vision tasks such as image segmentation and object detection. Therefore, in some embodiments the electronic device 100 may perform image dehazing in order to improve the image quality of the captured image. For example, the electronic device 100 may use the dehazing module 104 to perform an image dehazing process which may include estimating a clean image with improved visual quality. In embodiments, the clean image may refer to a haze-free image, or an image in which an effect of haze is reduced or eliminated.

The image quality degradation caused by the effects of haze may be formulated by Koschmieder's law, which may be expressed according to Equation 1 and Equation 2 below:

$$I ( x ) = J ( x ) t ( x ) + A ( 1 - t ( x ) ) \qquad Equation 1$$

$$t ( x ) = {e}^{- β d ( x )} \qquad Equation 2$$

In Equation 1 and Equation 2 above, I(x) may denote a real hazy image, which may be referred to as an observed hazy image, A may denote a global atmospheric light, t(x) may denote a transmission map, J(x) may denote a real clean image, which may be referred to as an observed clean image or a scene radiance, d(x) may denote a depth map, and β may denote a density coefficient, which may be referred to as a medium attenuation coefficient. Additionally, J(x)t(x) may be referred to as the direct attenuation, and A(1−t(x)) may be referred to as the airlight.

Accordingly, for a real hazy image I(x), the electronic device 100 may use the dehazing module 104 to estimate the global atmospheric light A, and to estimate the transmission function t(x) using the dehazing transformer model 1041, and may use the image generation module 1042 to generate an estimated real clean image J(x) using Equation 1 above based on the estimated global atmospheric light A and the estimated transmission function t(x).

In some embodiments a dark channel I^{dark}(x) may be used to estimate the global atmospheric light A. For example, in some embodiments, the top 0.1 percent brightest pixels in the dark channel I^{dark}(x) may be selected. Among these pixels, the pixel with highest intensity in the real hazy image I(x) may be considered as the global atmospheric light A. The dark channel I^{dark}(x) may be defined according to Equation 3 below:

$${I}^{dark} ( x ) = {min}_{y ∈ Ω ( x )} ( {min}_{c ∈ \{ r , g , b \}} {I}^{c} ( y ) ) \qquad ( Equation 3 )$$

In Equation 3 above, I^{c}(x) may denote a color channel of the real hazy image I(x), and Ω(x) may denote a local patch centered at x.

In some embodiments, the real hazy image I(x) may be an image which is captured using the camera module 103, but embodiments are not limited thereto. For example, in some embodiments the real hazy image I(x) may be an image which is received by the electronic device 100 from another device, and which is stored for example in the memory 102.

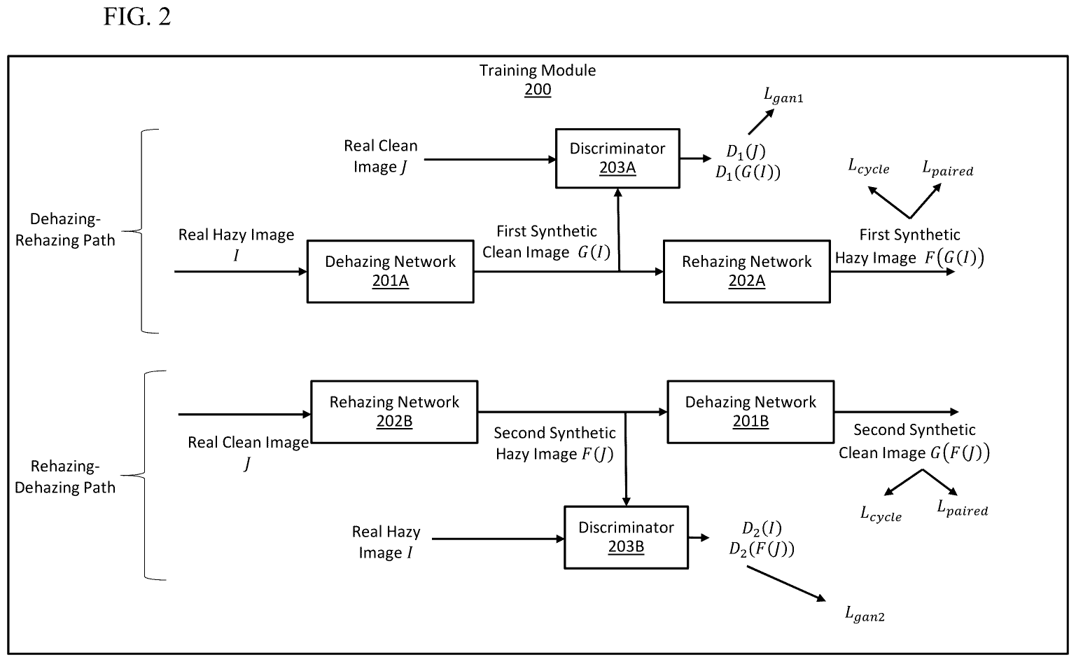

The training module 200 may include a dehazing network 201, a rehazing network 202, and a discriminator 203. In embodiments, at least one of the dehazing network 201, the rehazing network 202, and the discriminator 203 may be or may include a vision transformer, but embodiments are not limited thereto. In some embodiments, the discriminator 203 may include a plurality of discriminators (e.g., the discriminators 203A and 203B discussed below with reference to FIG. 2), but embodiments are not limited thereto. In embodiments, the dehazing network 201 may include the dehazing transformer model 1041, or for example the dehazing module 104 including the dehazing transformer model 1041. The dehazing network 201 may be used to apply a dehazing transformation to transform a hazy image H (e.g., the real hazy image I) to a clean image C, which may be denoted G: H→C. The rehazing network 202 may be used to apply a rehazing transformation to transform a clean image C (e.g., the real clean image J) to a hazy image H, which may be denoted F: C→H.

In embodiments, training module 200 may be used to train the rehazing network 202 and the dehazing network 201, including the dehazing transformer model 1041. For example, the training module 200 may train the rehazing network 202 and the dehazing network 201 by calculating or otherwise determining one or more losses, for example using the discriminator 203, and may adjust the rehazing network 202 and the dehazing network 201 based on the calculated losses, for example by adjusting weights of the rehazing network 202 and the dehazing network 201. Although the training module 200 is illustrated as being separate from the electronic device 100, embodiments are not limited thereto. For example, in some embodiments, the training module 200 may be included in the electronic device 100, or may be included in a separate device, for example a server device with which the electronic device 100 may communicate.

The dehazing problem may be an underdetermined problem, because it may involve, for example, 3N equations and 4N+3 unknowns, where N denotes the size of the image. Because of the scarcity of paired clean-hazy samples, some approaches to image dehazing, for example deep dehazing models, may use synthetic hazy data for training, which may result in over-fitting.

In contrast, embodiments are directed to a cyclic generative adversarial network (GAN) for training the dehazing network 201 and the rehazing network 202, which may allow training to be performed using both paired and unpaired image samples. Accordingly, embodiments may avoid over-fitting while using a relatively small number of paired hazy and clean image samples.

FIG. 2 is a block diagram showing a training module for training a dehazing transformer model, according to embodiments. In embodiments, the training module 200 may be arranged as, or may otherwise include, a cyclic GAN, which may receive a relatively small set of paired hazy and clean image samples (I,J) to improve the training by providing strong constraints for the dehazing, and to reduce the possibility of an under-constrained problem. The training module 200 may perform training according to two branches or paths, which may be referred to as a dehazing-rehazing path and a rehazing-dehazing path, respectively.

For convenience of description, FIG. 2 illustrates the two paths as including separate elements. For example, FIG. 2 illustrates the dehazing-rehazing path as including a dehazing network 201A, a rehazing network 202A, and a discriminator 203A, and illustrates the rehazing-dehazing path as including a rehazing network 202B, a dehazing network 201B, and a discriminator 203B. However, embodiments are not limited thereto. For example, the dehazing network 201A may represent a first instance of the dehazing network 201, or a first use of the dehazing network 201 (e.g., when the dehazing-rehazing path is executed), and the dehazing network 201B may represent a second instance of the dehazing network 201, or a second use of the dehazing network 201 (e.g., when the rehazing-dehazing path is executed). Similarly, the rehazing networks 202A and 202B may represent different instances or uses of the rehazing network 202, and the discriminators 203A and 203B may represent different instances or uses of the discriminator 203.

Accordingly, as shown in FIG. 2, in the dehazing-rehazing path, a real hazy image I may be transformed into a first synthetic clean image G(I) using the dehazing network 201A, and the first synthetic clean image G(I) may be transformed into a first synthetic hazy image F(G(I)) using the rehazing network 202A. In the rehazing-dehazing path, a real clean image J (which may be paired with the real hazy image I) may be transformed into a second synthetic hazy image F(J) using the rehazing network 202B, and the second synthetic hazy image F(J) may be transformed into a second synthetic clean image G(F(J)) using the dehazing network 201B.

In the dehazing-rehazing path, the discriminator 203A may generate discriminator output D₁(J) based on the real clean image J, and may generate discriminator output D₁(G(I)) based on the first synthetic clean image G(I). In the rehazing-dehazing path, the discriminator 203B may generate discriminator output D₂(I) based on the real hazy image J, and may generate discriminator output D₂(F(J)) based on the second synthetic hazy image F(J).

In embodiments, the training module 200 may perform training by calculating and minimizing a training loss L. The training loss L may be determined based on one or more different component losses. For example, the training loss L may be determined at least in part based on a cycle-consistency loss L_{cycle}, which may be expressed according to Equation 4 below:

$${L}_{cycle} ( F , G ) = {𝔼}_{( I , ∼ {p}_{data} ( I )} \{ {‖ F ( G ( I ) ) - I ‖}_{1} + {𝔼}_{J ∼ {p}_{data} ( J )} {‖ G ( F ( J ) - J ‖}_{1} \} \qquad Equation 4$$

In embodiments, the cycle-consistency loss L_{cycle} may be used to impose a condition that an intermediate image transferred from one domain may be transferred back.

The training loss L may also be determined at least in part based on a paired loss L_{paired}, which may be expressed according to Equation 5 below:

$${L}_{p a i r e d} ( F , G ) = {𝔼}_{( I , J ) ∼ {p}_{data} ( I , J )} \{ {‖ G ( I ) - J ‖}_{1} + {‖ F ( J ) - I ‖}_{1} \} \qquad Equation 5$$

The training loss L may also be determined at least in part based on adversarial losses corresponding to the discriminator 203 (or the discriminators 203A and 203B). For example, adversarial losses may be determined for the mapping functions G and F and the output of their corresponding discriminators.

As an example, a first adversarial loss L_{gan1} corresponding to the mapping function G: J→I may be expressed according to Equation 6 below:

$${L}_{g a n 1} ( G , {D}_{1} ) = {𝔼}_{J ∼ {p}_{data} ( J )} \{ log {D}_{1} ( J ) ) \} + {𝔼}_{1 ∼ {p}_{data} ( I )} \{ log ( 1 - {D}_{1} ( G ( I ) ) ) \} \qquad Equation 6$$

As another example, a second adversarial loss L_{gan2} corresponding to the mapping function F: I→J may be expressed according to Equation 7 below:

$${L}_{g a n 2} ( F , {D}_{2} ) = {𝔼}_{1 ∼ {p}_{data} ( I )} \{ log {D}_{2} ( I ) \} + {𝔼}_{J ∼ {p}_{data} ( J )} \{ log ( 1 - {D}_{2} ( F ( J ) ) ) \} \qquad Equation 7$$

In embodiments, the training loss L may be determined at least in part based on one or both of the first adversarial loss L_{gan1} and the second adversarial loss L_{gan2}.

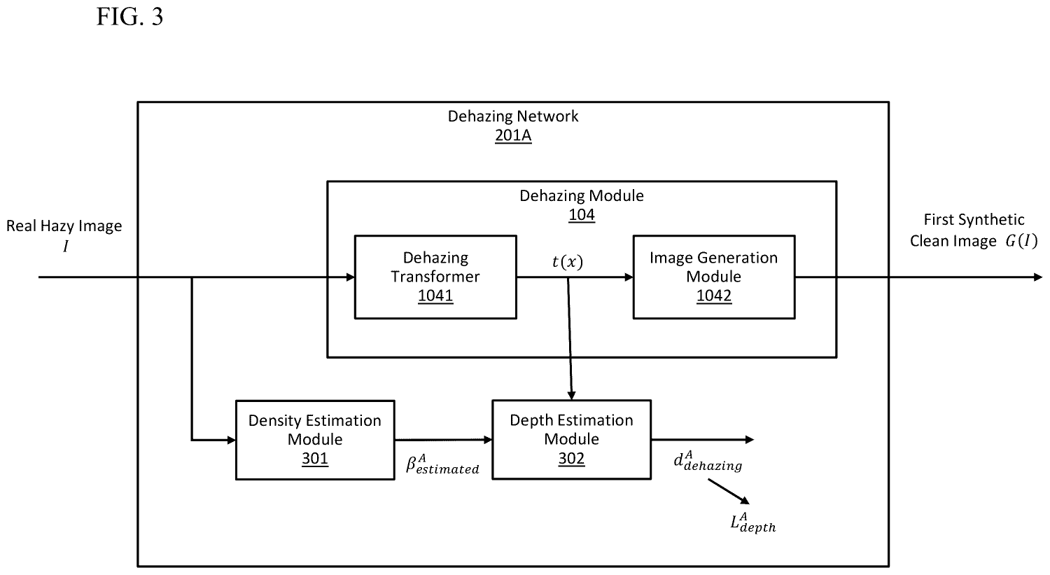

FIG. 3 is a block diagram showing a dehazing network included in a dehazing-rehazing branch, according to embodiments. As shown in FIG. 3, the dehazing network 201A may include the dehazing module 104 discussed above, including the dehazing transformer model 1041 and the image generation module 1042. The dehazing network 201A may further include a density estimation module 301 and a depth estimation module 302.

In embodiments, the dehazing transformer model 1041A may be, or may include, a UNet pixel-wise Vision Transformer (UNet-ViT) model, and the density estimation module may include a convolutional neural network (CNN), but embodiments are not limited thereto.

In embodiments, the dehazing network 201 may receive the real hazy image I, and may provide the real hazy image I to the dehazing module 104 and the density estimation module 301. The dehazing module 104 may generate an estimated global atmospheric light A, and may use the dehazing transformer model 1041 to generate an estimated transmission function t(x). The dehazing module 104 may further use the image generation module 1042 to generate the first synthetic clean image G(I). The density estimation module 301 may generate a first estimated density β_{estimated}^{A}. The depth estimation module 302 may generate an estimated dehazing depth map d_{dehazing}^{A} based on the first estimated density β_{estimated}^{A} and the estimated transmission function t(x).

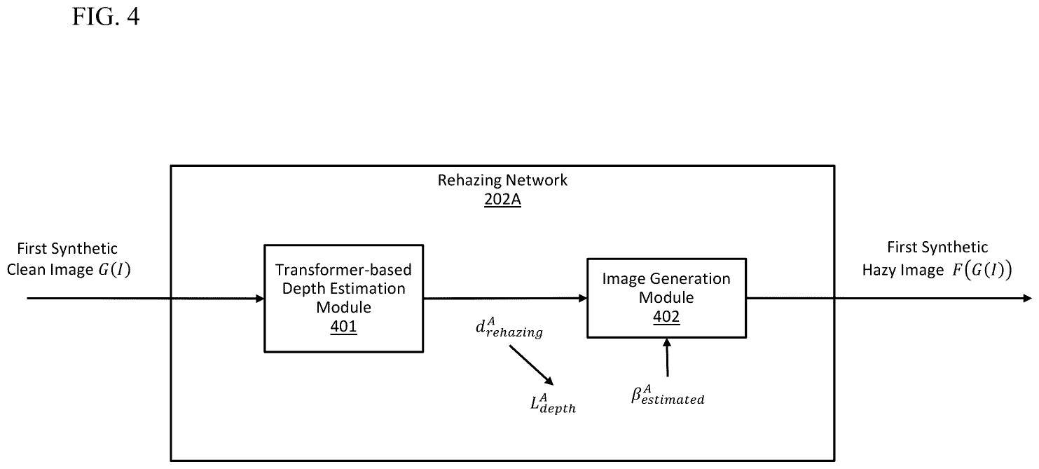

FIG. 4 is a block diagram showing a dehazing network included in a rehazing-dehazing branch, according to embodiments, according to embodiments. As shown in FIG. 4, the rehazing network 202A may include a transformer-based depth estimation module 401, which may generate an estimated rehazing depth map d_{rehazing}^{A} based on the first synthetic clean image G(I), and an image generation module 402, which may generate the first synthetic hazy image F(G(I)) based on the estimated rehazing depth map d_{rehazing}^{A} and the first estimated density β_{estimated}^{A}.

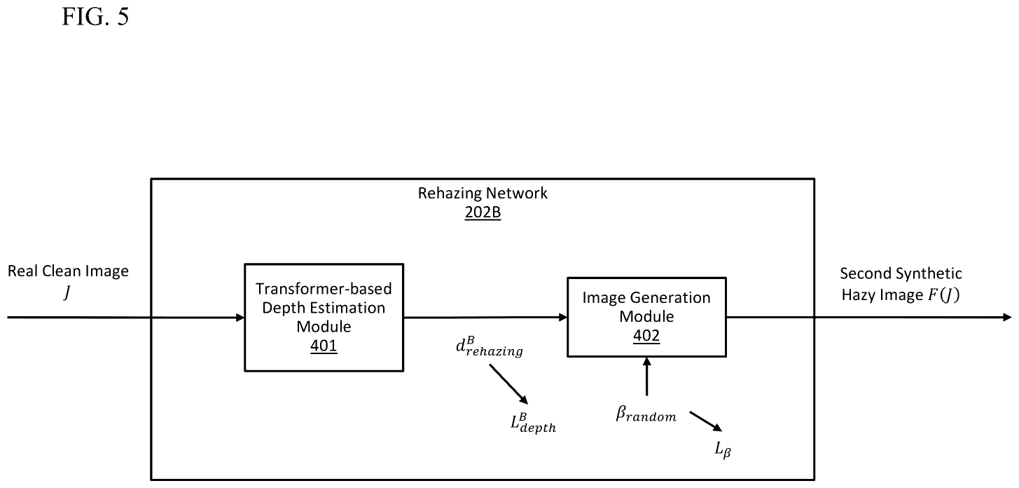

FIG. 5 is a block diagram showing a rehazing network included in a rehazing-dehazing branch, according to embodiments, according to embodiments. As shown in FIG. 5, the rehazing network 202B may include the transformer-based depth estimation module 401, which may generate an estimated rehazing depth map d_{rehazing}^{B} based on the real clean image J, and the image generation module 402, which may generate the second synthetic hazy image F(J) based on this estimated rehazing depth map d_{rehazing}^{B} and a randomly-generated density B_{random}.

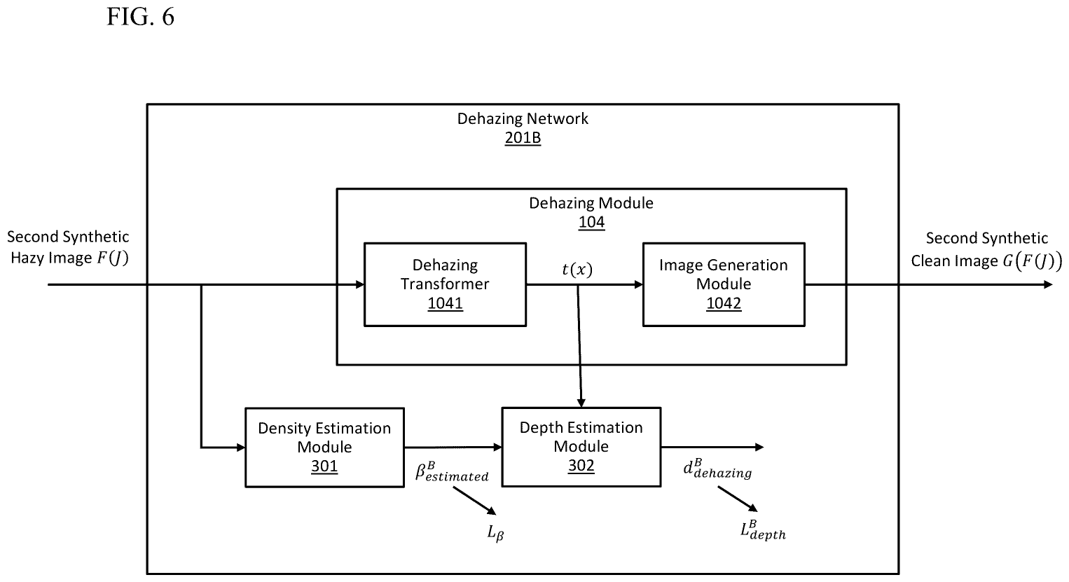

FIG. 6 is a block diagram showing a dehazing network included in a rehazing-dehazing branch, according to embodiments, according to embodiments. As shown in FIG. 6, the dehazing network 201B may include the dehazing module 104 discussed above, including the dehazing transformer model 1041 and the image generation module 1042. The dehazing network 201B may further include the density estimation module 301 and the depth estimation module 302.

In embodiments, the dehazing network 201B may receive the second synthetic hazy image F(J), and may provide the second synthetic hazy image F(J) to the dehazing module 104 and the density estimation module 301. The dehazing module 104 may generate an estimated global atmospheric light A, and may use the dehazing transformer model 1041 to generate an estimated transmission function t(x). The dehazing module 104 may further use the image generation module 1042 to generate the second synthetic clean image G(F(J)). The density estimation module 301 may generate a second estimated density β_{estimated}^{B}. The depth estimation module 302 may generate an estimated dehazing depth map d_{dehazing}^{B} based on the second estimated density β_{estimated}^{B} and the estimated transmission function t(x).

In embodiments, the training loss L may be determined at least in part based on a density loss L_{β}, which may be expressed according to Equation 8 below:

$${L}_{β} = {𝔼}_{J ∼ {p}_{data} ( J )} \{ {‖ {β}_{random} - {β}_{estimated}^{B} ‖}_{2} \} \qquad Equation 8$$

In embodiments, the density loss L_{β} may be used to impose a condition that the second estimated density β_{estimated}^{B} should match the random density B_{random}.

In embodiments, the training loss L may be determined at least in part based on a depth losses L_{depth}^{A} and L_{depth}^{B}, which may be expressed according to Equation 9 and Equation 10 below:

$${L}_{depth}^{A} = {𝔼}_{1 ∼ {p}_{data} ( I )} \{ {‖ {d}_{dehazing}^{A} - {d}_{rehazing}^{A} ‖}_{1} \} \qquad Equation 9$$

$${L}_{depth}^{B} = {𝔼}_{1 ∼ {p}_{data} ( I )} \{ {‖ {d}_{dehazing}^{B} - {d}_{rehazing}^{B} ‖}_{1} \} \qquad Equation 10$$

In embodiments, the depth losses L_{depth}^{A} and L_{depth}^{B} may be used to impose a condition that the depth maps along each path should match.

In embodiments, the training loss L may be calculated as a weighted sum of the four loss functions discussed above, as shown in Equation 9 below:

$$L = {α}_{1} {L}_{cycle} ( F , G ) + {α}_{2} {L}_{g a n 1} ( G , {D}_{1} ) + {α}_{3} {L}_{g a n 2} ( F , {D}_{2} ) + {α}_{4} {L}_{paired} ( F , G ) + {α}_{5} {L}_{β} + {α}_{6} {L}_{depth}^{A} + {α}_{7} {L}_{depth}^{B} \qquad Equation 11$$

In Equation 11 above, the weights α₁, α₂, α₃, α₄, α₅, α₆, and α₇ may denote training hyper-parameters, which may be used to adjust the training performed by the training module 200.

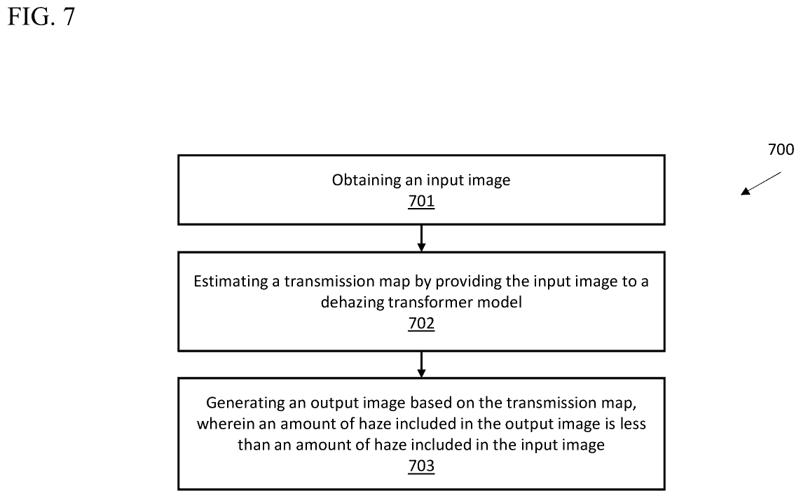

FIG. 7 is a flow chart of a process for performing image dehazing, according to embodiments. In some implementations, one or more process blocks of FIG. 7 may be performed by one or more of the elements discussed above, for example one or more of the image dehazing system 10 and any of the elements included therein, for example the electronic device 100.

As shown in FIG. 7, at operation 701 the process 700 may include obtaining an input image.

As further shown in FIG. 7, at operation 702 the process 700 may include estimating a transmission map by providing the input image to a dehazing transformer model. In embodiments, the dehazing transformer model may correspond to the dehazing transformer model 1041 included in the dehazing module 104 discussed above. In embodiments, the dehazing transformer model may be trained by performing a training process on a cyclic GAN including the dehazing transformer model, for example using the training module 200 discussed above. In embodiments, the training process may be performed using a plurality of unpaired samples and a plurality of paired samples, and the plurality of paired samples may include a plurality of real hazy images paired with a plurality of real clean images.

As further shown in FIG. 7, at operation 703 the process 700 may include generating an output image based on the transmission map, wherein an amount of haze included in the output image is less than an amount of haze included in the input image. In embodiments, the output image may be generated by the dehazing module 104 using the image generation module 1042 based on Equation 1 discussed above.

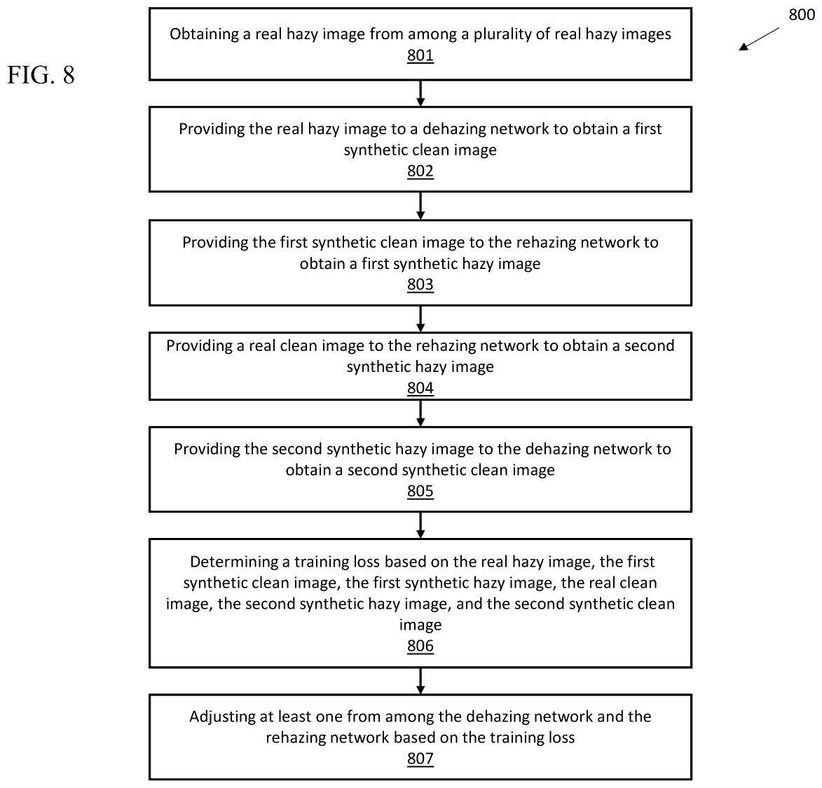

FIG. 8 is a flow chart of a process for training a cyclic GAN including a dehazing transformer model, according to embodiments. In some implementations, one or more process blocks of FIG. 8 may be performed by one or more of the elements discussed above, for example one or more of the image dehazing system 10 and any of the elements included therein, for example the training module 200.

As shown in FIG. 8, at operation 801 the process 800 may include obtaining a real hazy image from among a plurality of real hazy images.

As further shown in FIG. 8, at operation 802 the process 800 may include providing the real hazy image to a dehazing network to obtain a first synthetic clean image. In embodiments, the dehazing network may correspond to the dehazing network 201A discussed above.

As further shown in FIG. 8, at operation 803 the process 800 may include providing the first synthetic clean image to the rehazing network to obtain a first synthetic hazy image. In embodiments, the rehazing network may correspond to the rehazing network 202A discussed above.

As further shown in FIG. 8, at operation 804 the process 800 may include providing a real clean image to the rehazing network to obtain a second synthetic hazy image. In embodiments, the rehazing network may correspond to the rehazing network 202B discussed above.

As further shown in FIG. 8, at operation 805 the process 800 may include providing the second synthetic hazy image to the dehazing network to obtain a second synthetic clean image. In embodiments, the dehazing network may correspond to the dehazing network 201B discussed above.

As further shown in FIG. 8, at operation 806 the process 800 may include determining a training loss based on the real hazy image, the first synthetic clean image, the first synthetic hazy image, the real clean image, the second synthetic hazy image, and the second synthetic clean image. In embodiments, the training loss may be determined based on one or more of Equations 3-11 discussed above.

As further shown in FIG. 8, at operation 807 the process 800 may include adjusting at least one from among the dehazing network and the rehazing network based on the training loss. In embodiments, the adjusting may include adjusting weights of the at least one from among the dehazing network and the rehazing network.

Although FIGS. 7-8 show example blocks of processes 700 and 800, in some implementations, processes 700 and 800 may include additional blocks, fewer blocks, different blocks, or differently arranged blocks than those depicted in FIGS. 7-8. Additionally, or alternatively, two or more of the blocks of processes 700 and 800 may be performed in parallel.

Accordingly embodiments are directed to a dehazing transformer model which may be trained using a transformer-based cyclic GAN, which may use vision transformers in both a dehazing path and a rehazing path, for example in at least one of a dehazing network, a rehazing network, and a discriminator included in the cyclic GAN. The transformer-based cyclic GAN may be trained using paired image samples in addition to unpaired image samples.

As a result, embodiments may provide improved long-range spatial dependency regarding the clean and hazy images because of the relatively large receptive field provided by the vision transformers. In addition, embodiments may provide improved clean image reconstruction in terms of visual, and improved reconstruction of details because of the training using both paired samples and unpaired samples.

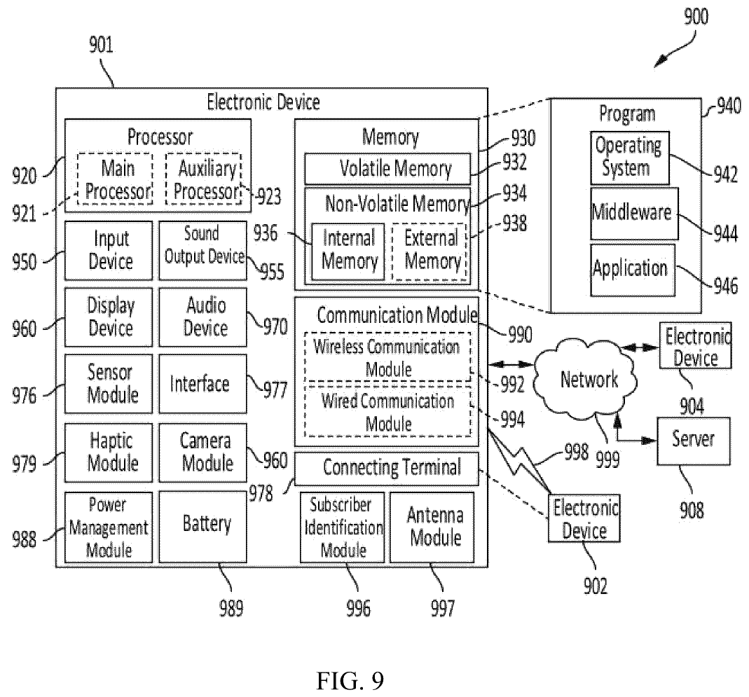

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display). In some embodiments, the electronic device 901 may correspond to the electronic device 100, the processor 920 may correspond to the processor 101, the memory 930 may correspond to the memory 102, and the camera module 980 may correspond to the camera module 103 discussed above, however embodiments are not limited thereto.

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

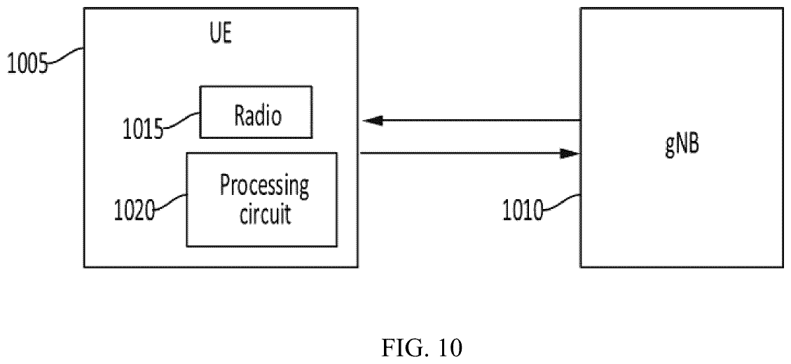

FIG. 10 shows a system including a UE 1005 and a gNB 1010, in communication with each other. The UE may include a radio 815 and a processing circuit (or a means for processing) 1020, which may perform various methods disclosed herein, e.g., the method illustrated in FIGS. 2 and 8A-8C. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of performing image dehazing, the method comprising:
obtaining an input image;
estimating a transmission map by providing the input image to a dehazing transformer model, wherein the dehazing transformer model is trained by performing a training process on a cyclic generative adversarial network (GAN) comprising the dehazing transformer model; and
generating an output image based on the transmission map,
wherein an amount of haze included in the output image is less than an amount of haze included in the input image.

2. The method of claim 1, wherein the training process is performed using a plurality of unpaired samples and a plurality of paired samples,
wherein the plurality of paired samples comprises a plurality of real hazy images paired with a plurality of real clean images, and
wherein a training loss for the training process is determined based on at least one from among a cyclic loss, a paired loss, a GAN loss, a density loss, and a depth loss.

3. The method of claim 2, wherein the cyclic GAN comprises a transformer-based dehazing network and a transformer-based rehazing network, and
wherein the dehazing transformer model is included in the dehazing network.

4. The method of claim 3, wherein the training process comprises:
obtaining a real hazy image from among the plurality of real hazy images;
providing the real hazy image to the dehazing network to obtain a first synthetic clean image; and
providing the first synthetic clean image to the rehazing network to obtain a first synthetic hazy image.

5. The method of claim 4, wherein the cyclic loss is determined based on a difference between the first synthetic hazy image and the real hazy image,
wherein the paired loss is determined based on a difference between the first synthetic clean image and a real clean image corresponding to the real hazy image from among the plurality of real clean images, and
wherein the GAN loss is determined based on the first synthetic hazy image and the real hazy image.

6. The method of claim 5, wherein the training process further comprises:
providing the real clean image to the rehazing network to obtain a second synthetic hazy image; and
providing the second synthetic hazy image to the dehazing network to obtain a second synthetic clean image.

7. The method of claim 6, wherein the cyclic loss is further determined based on a difference between the second synthetic clean image and the real clean image,
wherein the paired loss is further determined based on a difference between the second synthetic hazy image and the real hazy image, and
wherein the GAN loss is further determined based on the second synthetic clean image and the real clean image.

8. The method of claim 6, wherein the dehazing network further comprises a convolutional neural network (CNN),
wherein the second synthetic hazy image is generated by the rehazing network based on a random density coefficient,
wherein the training process further comprises generating an estimated density coefficient corresponding to the second synthetic hazy image using the CNN, and
wherein the density loss is determined based on a difference between the estimated density coefficient and the random density coefficient.

9. The method of claim 6,
wherein the training process further comprises:
generating an estimated transmission map based on at least one from among the real hazy image and the second synthetic hazy image using the dehazing transformer model;
generating an estimated dehazing depth map based on the estimated transmission map; and
generating an estimated rehazing depth map based on at least one from among the real clean image and the first synthetic clean image using the rehazing network, and
wherein the depth loss is determined based on a difference between the estimated dehazing depth map and the estimated rehazing depth map.

10. A system for performing image dehazing, the system comprising:
a training module configured to perform a training process on a cyclic generative adversarial network (GAN) comprising a dehazing transformer model; and
an electronic device configured to:
obtain an input image;
estimate a transmission map by providing the input image to the dehazing transformer model; and
generate an output image based on the transmission map,
wherein an amount of haze included in the output image is less than an amount of haze included in the input image.

11. The system of claim 10, wherein the training process is performed using a plurality of unpaired samples and a plurality of paired samples,
wherein the plurality of paired samples comprises a plurality of real hazy images paired with a plurality of real clean images, and
wherein a training loss for the training process is determined based on at least one from among a cyclic loss, a paired loss, a GAN loss, a density loss, and a depth loss.

12. The system of claim 11, wherein the cyclic GAN comprises a transformer-based dehazing network and a transformer-based rehazing network,
wherein the dehazing transformer model is included in the dehazing network.

13. The system of claim 12, wherein to perform the training process, the training module is further configured to:
obtain a real hazy image from among the plurality of real hazy images;
provide the real hazy image to the dehazing network to obtain a first synthetic clean image; and
provide the first synthetic clean image to the rehazing network included in the cyclic GAN to obtain a first synthetic hazy image.

14. The system of claim 13, wherein the cyclic loss is determined based on a difference between the first synthetic hazy image and the real hazy image,
wherein the paired loss is determined based on a difference between the first synthetic clean image and a real clean image corresponding to the real hazy image from among the plurality of real clean images, and
wherein the GAN loss is determined based on the first synthetic hazy image and the real hazy image.

15. The system of claim 14, wherein to perform the training process, the training module is further configured to:
provide the real clean image to the rehazing network to obtain a second synthetic hazy image; and
provide the second synthetic hazy image to the dehazing network to obtain a second synthetic clean image.

16. The system of claim 15, wherein the cyclic loss is further determined based on a difference between the second synthetic clean image and the real clean image,
wherein the paired loss is further determined based on a difference between the second synthetic hazy image and the real hazy image, and
wherein the GAN loss is determined based on the second synthetic clean image and the real clean image.

17. The system of claim 15, wherein the dehazing network further comprises a convolutional neural network (CNN),
wherein the second synthetic hazy image is generated by the rehazing network based on a random density coefficient,
wherein to perform the training process, the training module is further configured to generate an estimated density coefficient corresponding to the second synthetic hazy image using the CNN, and
wherein the density loss is determined based on a difference between the estimated density coefficient and the random density coefficient.

18. The system of claim 15,
wherein to perform the training process, the training module is further configured to:
generate an estimated transmission map based on at least one from among the real hazy image and the second synthetic hazy image using the dehazing transformer model;
generate an estimated dehazing depth map based on the estimated transmission map; and
generate an estimated rehazing depth map based on at least one from among the real clean image and the first synthetic clean image using the rehazing network, and
wherein the depth loss is determined based on a difference between the estimated dehazing depth map and the estimated rehazing depth map.

19. A non-transitory computer-readable medium storing instructions which, when executed by at least one processor of a device for performing image dehazing, causes the at least one processor to:
obtain an input image;
estimating a transmission map by providing the input image to a dehazing transformer model, wherein the dehazing transformer model is trained by performing a training process on a cyclic generative adversarial network (GAN) comprising the dehazing transformer model; and
generate an output image based on the transmission map,
wherein an amount of haze included in the output image is less than an amount of haze included in the input image.

20. The non-transitory computer-readable medium of claim 1, wherein the training process is performed using a plurality of unpaired samples and a plurality of paired samples,
wherein the plurality of paired samples comprises a plurality of real hazy images paired with a plurality of real clean images, and
wherein a training loss for the training process is determined based on at least one from among a cyclic loss, a paired loss, a GAN loss, a density loss, and a depth loss.
